(19) United States
(12) Patent Application Publication
(10) Pub. No.: US 2011/0214188 A1
(43) Pub. Date: Sep. 1, 2011

(54) SOFTWARE WATERMARKING TECHNIQUES

(75) Inventors: Christian Sven COLLBERG, Tucson, AZ (US); Clark David THOMBORSON, Auckland (NZ)

(73) Assignee: AUCKLAND UNISERVICES LIMITED, Auckland (NZ)

(21) Appl. No.: 12/946,796

(22) Filed: Nov. 15, 2010

Related U.S. Application Data
(63) Continuation of application No. 09/719,399, filed on Mar. 5, 2001, now abandoned.

(30) Foreign Application Priority Data
Jun. 10, 1998 (NZ) 330675

(51) Int. Cl. G06F 21/00

(52) U.S. Cl. 726/26

(57) ABSTRACT

A method and system for watermarking software is disclosed. In one aspect, the method and system include providing an input sequence and storing a watermark in the state of a software object as the software object is being run with the input sequence. In another aspect, the method and system verify the integrity or origin of a program by watermarking the program. The watermark is stored as described above. In this aspect, the method and system also include building a recognizer concurrently with the input sequence and the watermark. The recognizer can extract the watermark from other dynamically allocated data and is kept separately from the program. The recognizer is adapted to check for a number. In another aspect, the software is watermarked by embedding a watermark in a static string and applying an obfuscation technique to convert the static string into executable code. In another aspect, the watermark is chosen from a class of graphs having a plurality of members and applied to the software. Each member of the class of graphs has at least one property that is capable of being tested by integrity-testing software.

### FIELD OF THE INVENTION

The present invention relates to methods for protecting software against theft, establishing/proving ownership of software and validating software. More particularly, although not exclusively, the present invention provides for methods for watermarking what will be generically referred to as software objects. In this context, software objects may be understood to include programs and certain types of media.

### BACKGROUND TO THE INVENTION

Watermarking is the process of embedding a secret message, the watermark, into a cover or overt message. For example, in media watermarking, the secret is commonly a copyright notice and the cover is a digital image, video or audio recording. Fingerprinting is a method whereby each individual software application incorporates a, potentially, unique, watermark which allows that particular example of the software to be identified. Fingerprinting may be viewed as a multiple use of watermarking techniques.

The watermark is constructed to make it difficult to remove the watermark without damaging the software object in which it is embedded. Such watermarks may only be removed safely by someone (or some process) in possession of one or more secrets that were employed while constructing the watermark.

Watermarking a software object (hereafter referred to as an object) discourages intellectual property theft. A further application is that watermarking an object can be used to establish and/or prove evidence of ownership of an object. Fingerprinting is similar to watermarking except a different watermark is embedded in every cover message thus providing a unique fingerprint for every object. Watermarking is therefore a subset of fingerprinting and the latter may be used to detect not only the fact that a theft has occurred, but may also allow identification of the particular object and thus establish an audit trail which can be used to reveal the infringer of copyright.

In the context of prior art watermark techniques, the following scenario serves to illustrate the ways in which a watermarked object may be vulnerable to attack. With reference to FIG. 1, suppose that A watermarks an object O with a watermark W and key K. If the object O is sold to Band B wishes to (illegally) on-sell O to C, there are various types of attack to which O may be vulnerable.

Detection: initially B must try and detect the presence of the watermark in O. If there is no watermark, no further action is necessary.

Locate and remove: once B has determined that O carries a watermark, B may try to locate and remove W without otherwise harming the rest of the contents of O.

Distort: if some degradation in quality of O is acceptable, B may distort it sufficiently so that it becomes impossible for A to detect the presence of the watermark Win the object O.

Add: alternatively, if removing the watermark W is too difficult, or distorting the object O is not acceptable, B might simply add his own watermark W′ (or several such marks) to the object O. This way, A's mark becomes just one of many.

It is considered that most media watermarking schemes are vulnerable to attack by distortion. For example, image transforms such as cropping and lossy compression will distort the image sufficiently to render many watermarks unrecoverable.

To the knowledge of the applicants there exists no effective watermarking scheme which is capable of use with or appropriate for software. It would be a significant advantage to be able to apply watermarking techniques to software in view of the widespread occurrence of software piracy. It is estimated at software piracy costs approximately 15 billion dollars per year. Thus the problem of software security and protection is of significant commercial importance.

One simple way, known in the prior art, of embedding a watermark in a piece of software is simply to include it in the initialized static data section of the object code. In a similar, yet more complex manner, watermarks are often encoded in what is known as an. “Easter egg”. This is a piece of code, which is activated for a highly unusual or seldom encountered input to the particular application, which displays a watermark image, plays a watermark sound, or, in some way, alerts the user that the watermark code has been activated.

Thus, it is an object of the present invention to provide methods for watermarking software objects which overcomes the limitations inherent in prior art watermarking techniques and allows for non-media objects to be watermarked effectively. It is a further object of the present invention to provide methods for watermarking software objects which are resistant to the aforementioned techniques for attacking watermark objects or to at least provide the public with a useful choice.

### DISCLOSURE OF THE INVENTION

In one aspect, the invention provides for a method of watermarking a software object whereby a watermark is stored in the state of the software object as it is being run with a particular input sequence.

The software object may be a program or piece of program.

When a software object is executed on a computer system, the computer system develops an execution state for the object. In “Modularization and Hierarchy in a Family of Operating Systems”, A. Nico Habermann, Lawrence Flon, Lee W. Cooprider, Commun. ACM 19 (5): 266-272 (1976) (“Habermann”), a software object is called a module, and Habermann teaches that a module is instantiated whenever it is executed by a computer system. The static representation, or text, of a software object is determined at the time it is created, typically by a compiler or assembler. Habermann teaches that an operating system instantiates a module, in part, by allocating some memory locations in the computer system. These dynamically-allocated memory locations are used to store the values in the execution state relating to this particular instantiation. The execution state of a software object is modified by the computer system, when the computer system performs the operations specified by the instructions contained in the software object. It is common in the prior art to distinguish the code section(s) of the text from the data section(s) of the text. Code sections of a software object contain instructions for the computer system, and data sections contain variables referenced by these instructions. The data sections in the text may hold initial values for variables.

In “Heterogeneous process migration by recompilation”, M. M. Theimer, B. Hayes, Proc. 11th Int'l Conf. on Distributed Computing Systems, 1991, pp. 18-24. DOI: 10.1109/ICDCS. 1991 (“Theimer”) and “The Use of Program Profiling for Software Maintenance with Applications to the Year 2000 Problem”, Thomas W. Reps, Thomas Ball, Manuvir Das, James R. Larus in Proceedings of the 6th European SOFTWARE ENGINEERING Conference (ESEC/SIGSOFT FSE, Zurich, 22-25 Sep. 1997), Lecture Notes in Computer Science Vol. 1301, Springer, 1997, pp. 432-449 (“Reps”), an execution state is subdivided into a control state and a data state. The term “process” in this art corresponds to an “instantiated module” in the art of Habermann. Theimer teaches how to migrate a process by transferring its execution state to another computer by “ . . . building a machine-independent migration program that specifies the current code and data state of the process to be migrated . . . . There are typically three kinds of data space in a program: global data, heap data, and procedure local data.” Reps teaches that an execution state can be represented as a combination of code state and data state of the form “(pt, \sigma), where \sigma is a store value and pt is not an arbitrary program point, but one occurring at the beginning of a path p that the profiler is prepared to tabulate.” A path is a sequence of instructions that were executed from the text. A path may be represented as a series of instruction addresses, i.e. as a series of references to individual instructions in the text. A path may also be represented, more compactly, as “a sequence of edges in the program's control-flow graph” (Reps).

An execution trace is any sequence of execution states or any sequence of partial execution states. A program path p in the art of Reps 1997 is an example of a trace. Such a path is sometimes called an “address trace” because it will reveal, to a program analyst, the series of starting addresses of the basic blocks in the program's code that were executed during previous execution states of the program.

In a preferred embodiment, the watermark may be stored in an object's execution state whereby a (possibly empty) input sequence I is constructed which, when fed to an application of which the object is a part, will make the object O enter a state which represents the watermark, the representation being validated or checked by examining the dynamically allocated data structures of the object O.

In an alternative embodiment, the watermark could be embedded in the execution trace of the object O whereby, as a special input I is fed to O, the address/operator trace is monitored and, based on a property of the trace, a watermark is extracted.

In a preferred embodiment, the watermark is embedded in the state of the program as it is being run with a particular input sequence I=I₁ . . . Iₖ.

The watermark may be embedded in the topology of a dynamically built graph structure.

The graph structure (or watermark graph) corresponds to a representation of the data structure of the program and may be viewed as a set of nodes together with a set of vertices.

The method may further comprise building a recognizer R concurrently with the input I and watermark W.

Preferably R is a function adapted to identify and extract the watermark graph from all other dynamically allocated data structures.

In an alternative, less preferred embodiment, the watermark W may incorporate a marker that will allow R to recognize it easily.

In a preferred embodiment, R is retained separately from the program whereby R is dynamically linked with the program when it is checked for the existence of a watermark.

Preferably the application of which the object forms a part is obfuscated or incorporates tamper-proofing code.

In a preferred embodiment, R extracts a value n from the topology of the graph comprising the watermark W.

The watermark W has a signature property s where s(W) evaluates to “true” if the watermark W is recognisable wherein the recogniser R tests a presumed watermark W by evaluating the signature property s(W).

In a preferred embodiment, the method includes the creation of a number n which may be embedded in the topology of a watermark graph, wherein the signature property s(W) is a function of a number n so embedded.

In a preferred embodiment, the signature property s(W) is “true” if and only if the number n is the product of two primes.

The invention further provides for a method of verifying the integrity or origin of a program including:

watermarking the program with a watermark W in the state of a program as the program is being run with a particular input sequence I;
building a recognizer R concurrently with the input I and watermark W wherein the recognizer is adapted to extract the watermark graph from other dynamically allocated data structures wherein R is kept separately from the program; wherein R is adapted to check for a number n, n, in a preferred embodiment, being the product of two primes and wherein n is embedded in the topology of W.

Preferably, the signature property may be evaluated by testing for a specific result from a hard computational problem.

The number n may be derived from any combination of numbers depending on the context and application.

Preferably the program or code is further adapted to be resistant to tampering, preferably by means of obfuscation or by adding tamper-proofing code.

Preferably the watermarks W are chosen from a class of graphs G wherein each member of G has one or more properties, such as planarity, said property being capable of being tested by integrity-testing software.

In an alternative embodiment, the watermark may be rendered tamperproof to certain transformations, such as attacks, by expanding each node of the watermark graph into a j-cycle, where j may be any number from 1 to 5.

In a broad aspect, the recognizer R checks for the effect of the watermarking code on the execution state of the application thereby preserving the ability to recognize the watermark in cases where semantics-preserving transformations have been applied to the application.

In a further aspect, the invention provides for a method of watermarking software including the steps of:

embedding a watermark in a static string, then applying an obfuscation technique whereby this static string is converted into executable code.

The executable code is called whenever the static string is required by the program.

### BRIEF DESCRIPTION OF THE DRAWINGS

The present invention will now be described by way of example only and with reference to the figures in which:

FIG. 1: illustrates methods of adding a watermark to an object and attacking the integrity of such a watermark;

FIG. 2: illustrates methods of embedding a watermark in a program;

FIG. 3: illustrates an example of a function used to embed a watermark within a static string;

FIG. 4: illustrates insertion of a bogus predicate into a program;

FIG. 5: illustrates splitting variables;

FIG. 6: illustrates merging variables;

FIG. 7: illustrates the conversion of a code section into a different virtual machine code;

FIG. 8: illustrates an example of a method of the watermarking scheme according to the present invention;

FIG. 9: illustrates a possible encoding method for embedding a number in the topology of a graph;

FIG. 10: illustrates another possible embodiment for embedding a number in the topology of a graph;

FIG. 11: illustrates a marker in a graph;

FIG. 12: illustrates examples of obfuscating transformations;

FIG. 13: illustrates examples of tamperproofing Java code;

FIG. 14: illustrates enumeration encoding in a planted plane cubic tree on 2m=8 nodes; and

FIG. 15: illustrates tamperproofing against node-splitting.

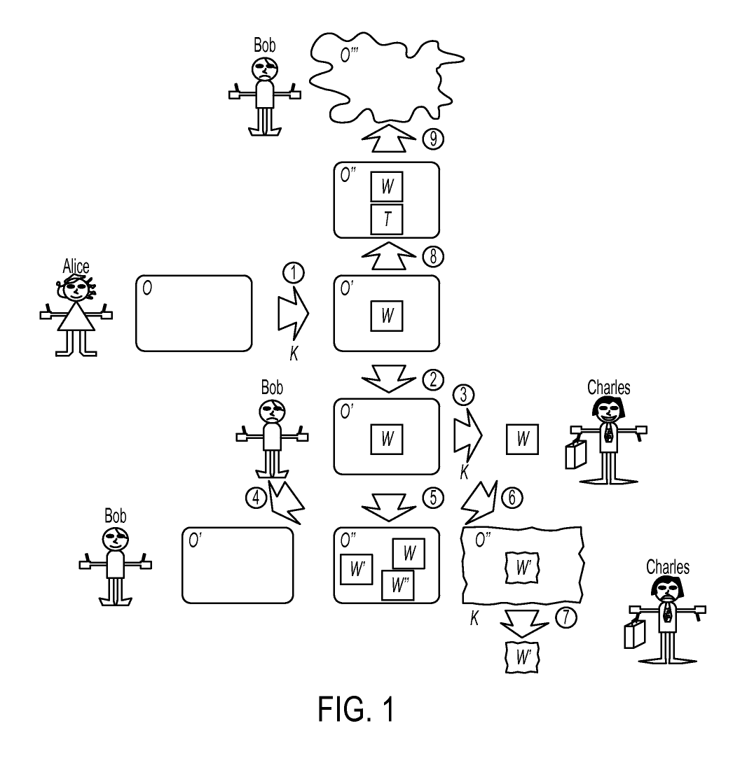

Referring to FIG. 1(b) a way is shown by which Bob can circumvent a watermarking scheme by distorting the protected object. If the distortion is at “just the right level”, O will still be usable by Bob, but Charles will be unable to extract the watermark. In FIG. 1(9), the distortion is so severe that O is no longer functional, so Bob will not be able to use it, nor is he able to on-sell it.

In the present context, tamperproofing is applied in order to prevent an adversary from removing the watermark and to provide assurance to the software end-user that the software object hasn't been tampered with. Thus the ‘integrity’ of the program may be verified. The primary aim of the present invention is to allow accurate assertion of ownership of a software object with a secondary purpose being to ensure the integrity of the object.

It has been shown that there are transformations, called obfuscating transformations, that will destroy almost any kind of program structure while preserving the semantics (operational behaviour) of the program. Other semantics preserving transformations, such as optimising transformations known from the prior art can be used to similar effect. As a consequence, any software watermarking technique must be evaluated with respect to its resilience to attack from automatic application of semantics preserving transformations, such as obfuscation. The following discussion will survey obfuscating transformations that can be used to destroy software watermarks.

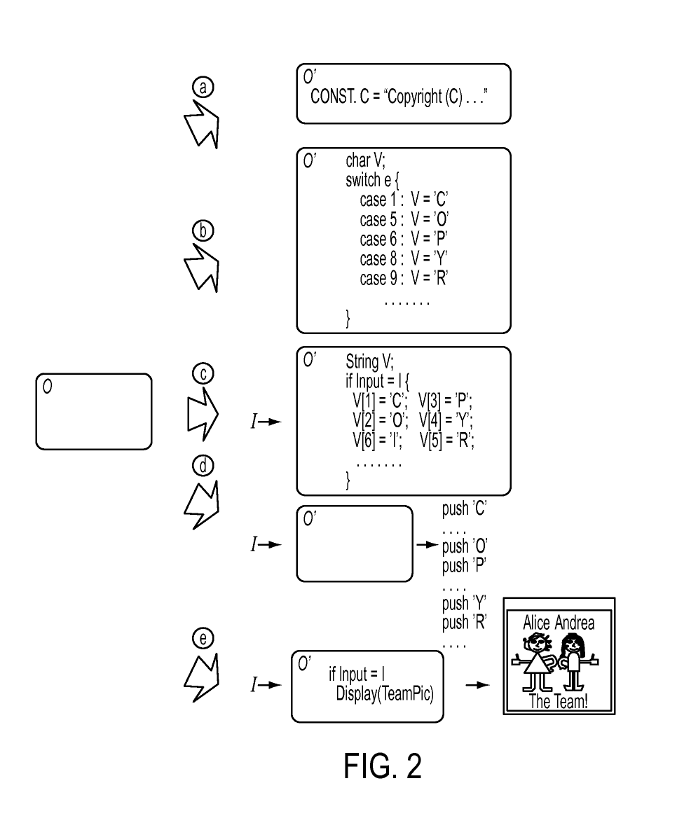

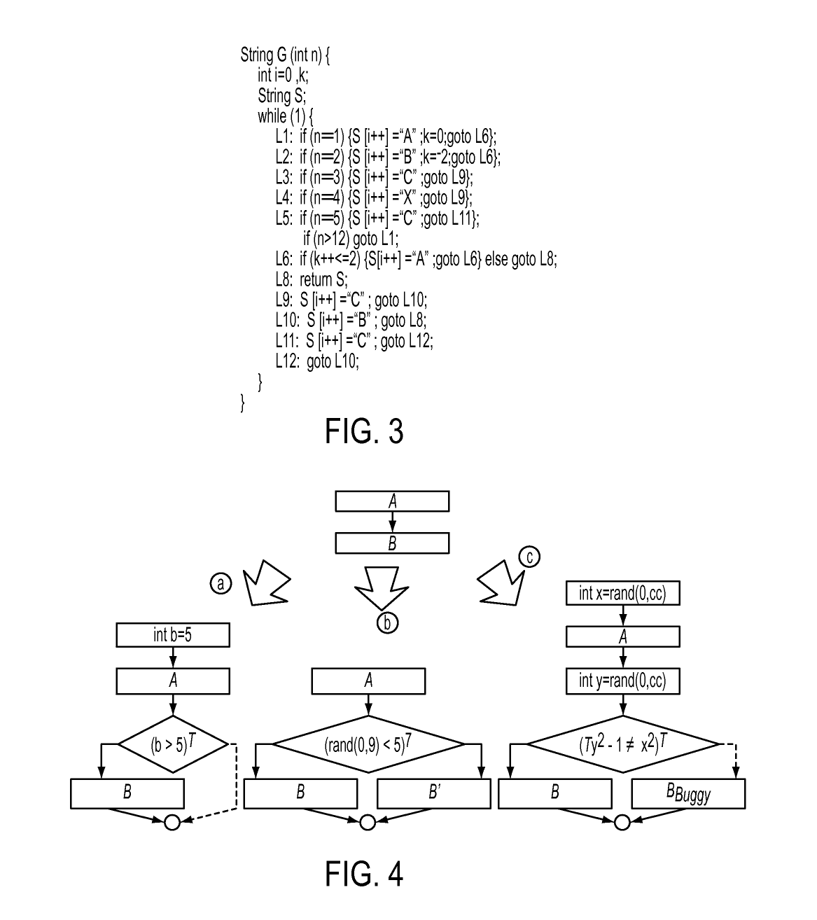

In FIG. 2a a watermark is embedded within a static string. There are several ways of rendering watermarks unrecogisable, the most effective perhaps by converting static strings into a program that produces the data. As an example, consider the function G in FIG. 3. This function was constructed to obfuscate the strings “AAA”, “BAAAA”, and “COB”. The values produced by G are G(1)=“AAA”, G(2)=“BAAAA”, G(3)=G(5)=“CCB”, and G(4)=“XCB”.

In FIG. 2b Alice embeds a watermark within the program code itself. There are numerous ways to attack such code. FIG. 4, for example, shows how it is possible to insert bogus predicates into a program. These predicates are called opaque since their outcome is known at obfuscation time, but difficult to deduce otherwise. Highly resilient opaque predicates can be constructed using hard static analysis problems such as aliasing.

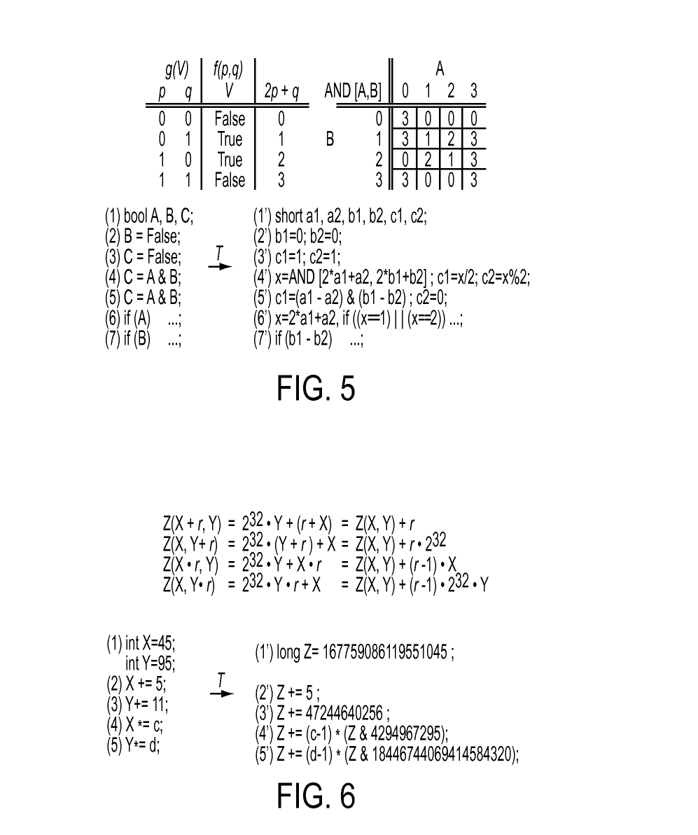

In FIG. 2c a watermark is embedded within the state (global, heap, and stack data, etc.) of the program as it is being run with a particular input I. Different obfuscation techniques can be employed to destroy this state, depending on the type of the data. For example, one variable can be split into several variables (FIG. 5) or several variables can be merged into one (FIG. 6).

In FIG. 2d a watermark is embedded within the trace (either instructions or addresses, or both) of the program as it is being run with a special input sequence I=I₁, I₂, . . . Iₖ. In an alternative embodiment, a watermark may be embedded within a series of execution traces, said series of traces being generated as the program is run on a special input. This special input is comprised of a series of one or more input sequences, where each input sequence is generated by a specific process which may incorporate a random or pseudorandom number generator. Execution traces have many properties that may be observed by a watermark recogniser R. One example of such a property is “if the program passes point P1 in O, then there's a 32% chance that it will also pass point P2”. Another example of such a property is the frequency at which some specific basic operation, such as addition, is performed. A specific collection of (one or more) such execution-trace properties is the watermark W. The signature property s(W) for this W is that all the property values are within some predefined tolerance. For example, we might require that our sample property P1-P2 have a value between 30% and 34% on a randomly-generated series of 10000 inputs (note that we would not expect to observe an “exact match” to our 32% estimated mean-value for this property P1-P2, because each randomly-generated series of inputs would give us a somewhat different measurement for this property value).

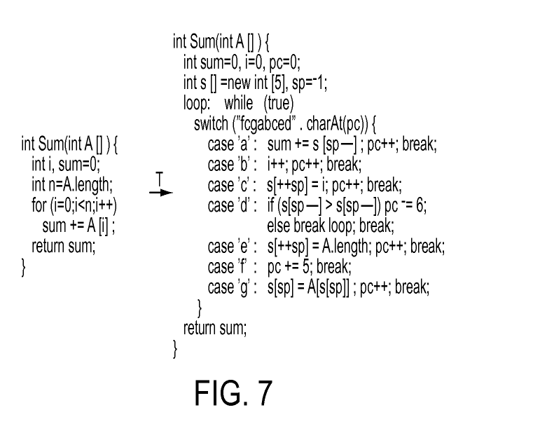

Many of the same transformations that can be used to obfuscate code will also obfuscate an instruction trace. FIG. 7 shows another, more potent, transformation. The idea is to convert a section of code (Java bytecode in our case) into a different virtual machine code. The new code is then executed by a virtual machine interpreter included with the obfuscated application. The execution trace of the new virtual machine running the obfuscated program will be completely different from that of the original program. In FIG. 2e, a watermark is embedded in an Easter Egg. Unless the code is obfuscated, Easter Eggs may be found by straightforward techniques such as decompilation and disassembly.

In this section, techniques for embedding software watermarks in dynamic data structures are discussed. The inventors view these techniques as the most promising for withstanding de-watermarking attacks by obfuscation.

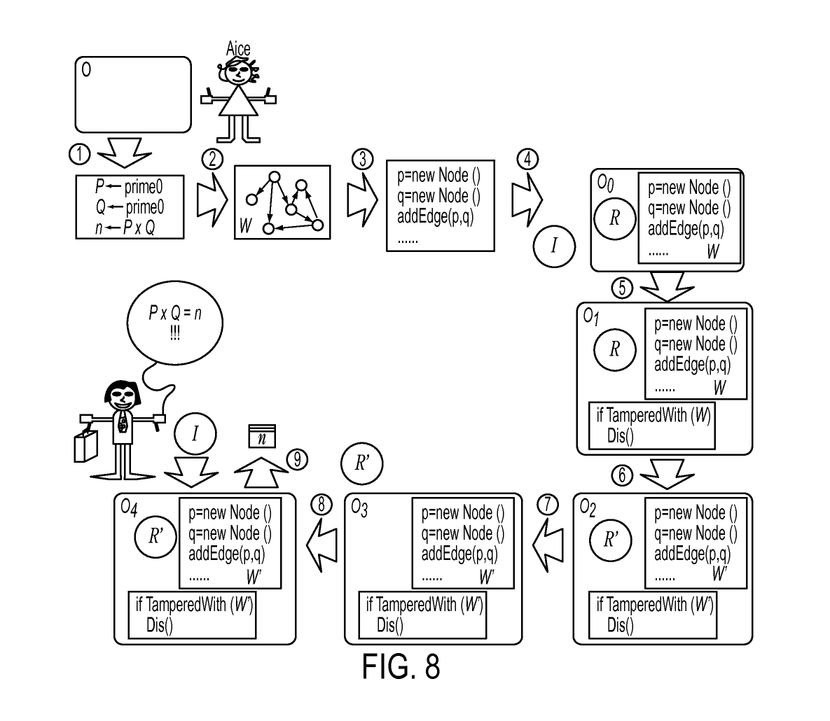

The basic structure of the proposed watermarking technique is outlined in FIG. 8. The method is as follows:

1. The watermark W is embedded, not in the static structure of the program, its code (Unix text segment), its static data (Unix initialised data segment), or its type information (Unix symbol segment or Java's Constant Pool), but rather in the state of the program as it is being run with a particular input sequence I (of length k) whose elements are I=I₁, I₂, . . . Iₖ. Of course k may be 0, in which case there is no input and the input sequence is empty.
2. More specifically, the watermark is embedded in the topology of a dynamically built graph structure. It is believed that obfuscating the topology of a graph is fundamentally more difficult than obfuscating other types of data. Moreover, it is anticipated that tamperproofing such a structure should be easier than tamperproofing code or static data. This is particularly true of languages like Java, where a program has no direct access to its own code.
3. A Recogniser R is built along with the input I and watermark W. R is a function that is able to identify and extract the watermark graph from among all other dynamic allocated data structures. Since, in general, sub-graph isomorphism is a difficult problem, it is possible that W will have some special marker that will allow R to recognise W easily. Alternatively, W may be formed immediately after input Iₖ is processed, i.e. markers may not be necessary. Markers are considered ‘unstealthy’ for the following reason. If a marker is easily recognisable by a recogniser, an adversary might discover it—perhaps by way of a collusive attack on a collection of fingerprinted objects. The use of markers can be avoided by exploiting the recogniser's knowledge of the secret input sequence in the following way: the watermark will be completed immediately after the k^{th} input (Iₖ) of this sequence is presented to the program. The recogniser knows the value of “k” and therefore is able to look for the watermark graph effectively, by examining the nodes that were allocated or modified during the processing of Iₖ. In contrast, the adversary would be unaware of the length of this sequence and would therefore have to “guess’ a value of “k” as well as the values (I₁, I₂ . . . Iₖ) in the input sequence I, before looking for the watermark.
4. An important aspect of the proposed technique is that R is not distributed along with the rest of the program. If it were, a potential adversary could identify and decompile it, and discover the relevant property of W. R is employed only when we check for the watermark. R may be an extension of the program comprised of self-monitoring code, or it may be an adjunct to a debugger or some other external means for examining the dynamic state of the program. R may be linked in dynamically with the program when we check for the watermark. Other mechanisms are envisaged by which the recogniser R may observe the state of the object O.
5. It is required that some signature property s(W) of W be highly resilient to tampering. This can be achieved, for example, by obfuscation or by adding tamperproofing code to the application.
6. In FIG. 8 it is assumed that the signature that R checks for is a number n, which has been embedded in the topology of W. n is the product of two large primes P and Q. To prove the legal origin of the program, we link in R, run the resulting program with I as input, and show that we can factor the number that R produces. Alternatively, s(W) can be based on hard computational problems other than factorisation of large integers.

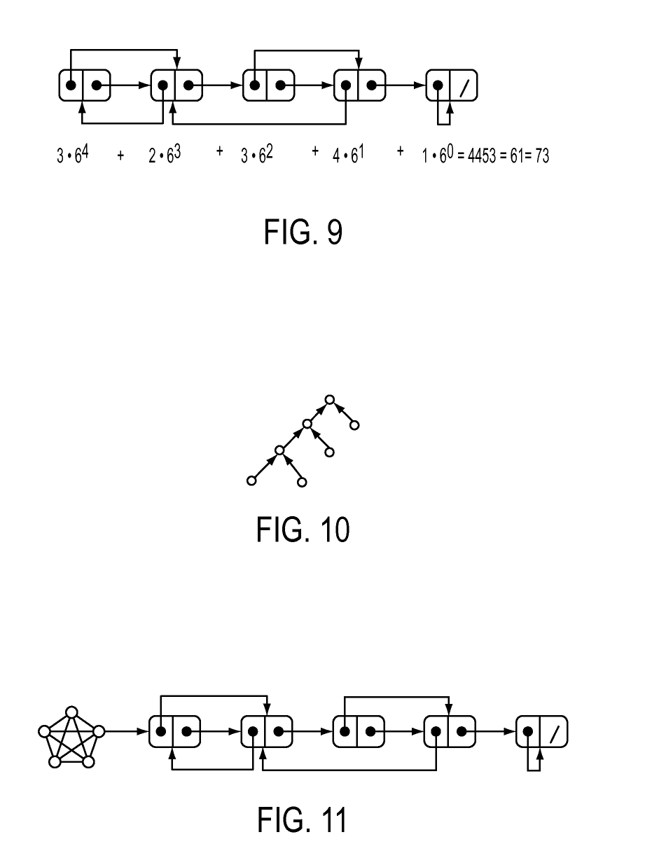

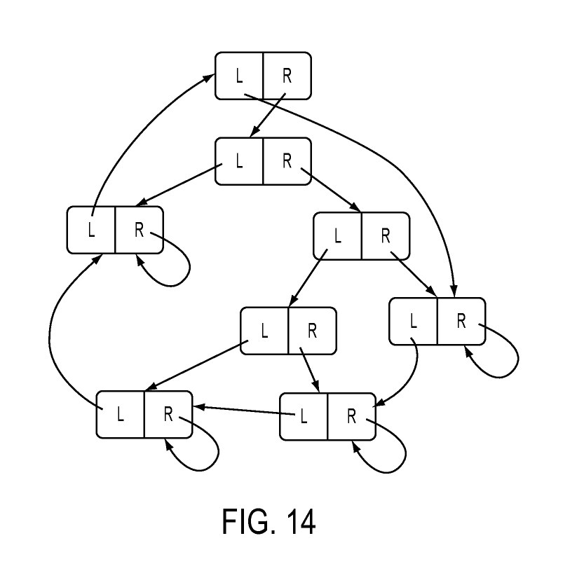

The above issues will now be discussed in more detail. The first problem to be solved is how to embed a number in the topology of a graph. There are a number of ways of doing this, and, in fact, a watermarking tool should have a library of many such techniques to choose from. FIG. 9 illustrates one possible encoding. The structure is basically a linked list with an extra pointer field which encodes a base-6 digit. A null-pointer encodes a 0, a self-pointer a 0, a pointer to the next node encodes a 1, etc. A further example is shown in FIG. 14 whereby the watermark W is chosen from a class of graphs G wherein each member of G has one or more properties (in FIG. 14—planarity) that may be tested by integrity-checking software. The integrity checking software may be incorporated into the program during the watermarking process.

In the previous paragraph, it was shown how an integer n could be encoded in the topology of a graph. The encoding is resilient to tampering, as long as the recogniser R is able to correctly identify the nodes containing the two pointer fields in which we have encoded n. We now describe another encoding showing that a recogniser R can evaluate n if it can identify only a single pointer field per node.

Using a single pointer per node, we can construct a watermark Win the form of a parent-pointer tree. The parent-pointer tree W is a representation of a graph G known as an oriented tree enumerable by the techniques described in Knuth, Vol I 3^{rd} Edition, Section 2.3.4.4.

The number aₘ of oriented trees with m nodes is asymptotically aₘ=c(1/α)ⁿ⁻¹/n^{3/2}+O((1/α)ⁿ/n^{5/2}) for c ˜0.44 and 1/α˜2.956. Thus we can encode an arbitrary 1000-bit integer n in a graphic watermark W with 1000/log₂2.956˜640 nodes.

We construct an index n for any enumerable graph in the usual way, that is, by ordering the operations in the enumeration. For example, we might index the trees with m nodes in “largest subtree first” order, in which case the path of length m−1 would be assigned index 1. Indices 2 through aₘ₋₁ would be assigned to the other trees in which there is a single subtree connected to the root node. Indices aₘ₋₁+1 through aₘ₋₁+aₘ₋₂ would be assigned to the trees with exactly two subtrees connected to the root node, such that one of the subtrees has exactly m−2 nodes. The next aₘ₋₃a₂=aₘ₋₁ indices would be assigned to trees with exactly two subtrees connected to the root node, such that one of the subtrees has exactly m−3 nodes. See FIG. 10 for an example.

To aid the recognition of a watermark, the recogniser may use secret knowledge of a “signal” indicating that “the next thing that follows” is the real watermark. In a preferred embodiment, the secret is the input sequence I; the recogniser (but not the attacker) knows that the watermark will be constructed after the input sequence I=I₁, I₂ . . . Iₖ has been processed. In an alternative, but less preferred embodiment, the secret is an easily recognisable “marker” that may be present in the watermark graph. This is similar to the signals used between baseball coaches and their players. See FIG. 11 for an example.

One advantageous consequence of the present approach is that semantics-preserving transformations, such as those employed in optimising compilers and those employed by obfuscation techniques which target code and static data will have no effect on the dynamic structures that are being built. There are, however, other techniques which can obfuscate dynamic data, and which we will need to tamperproof against. There are three types of obfuscating transformations which will need to be protected against:
1. An adversary can add extra pointers to the nodes of linked structures. This will make it hard for R to recognise the real graph within a lot of extra bogus pointer fields.
2. An adversary can rename and reorder the fields in the node, again making it hard to recognise the real watermark.
3. Finally, an adversary can add levels of indirection, for example by splitting nodes into several linked parts.

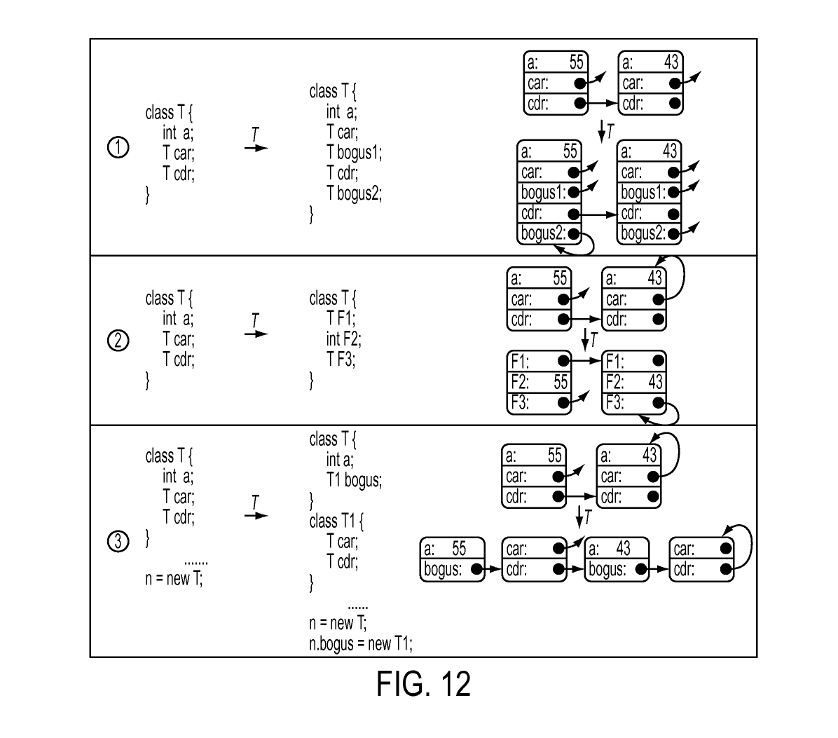

These transformations are illustrated in FIG. 12. It is important to note here that obfuscating linked structures has some potentially serious consequences. For example, splitting nodes will increase the dynamic memory requirement of the program (each cell carries a certain amount of overhead for type information etc.), which could mean that a program which ran on, say, a machine with 32M of memory would now not run at all. Furthermore, if we assume that an adversary does not know in which dynamic structure our watermark is hidden, he is going to have to obfuscate every dynamic memory allocation in the entire program.

Next will be discussed techniques for tamperproofing a dynamic watermark against the obfuscation attacks outlined above.

The types of tamperproofing techniques that will be available will depend on the nature of the distributed object code. If the code is strongly typed and supports reflection (as is the case with Java bytecode) we can use these reflection capabilities to construct the tamperproofing code. If, on the other hand, the application is shipped as stripped, untyped, native code (as is the case with most programs written in C, for example) this possibility is not open to us. Instead, we can insert code which manipulates the dynamically allocated structures in such a way that obfuscating them would be unsafe.

ANSI C's address manipulation facilities and limited reflection capabilities allow for some trivial tamperproofing checks:

```
include <stdlib.h>
include <stddef.h>
struct s int a; int b;;
void main ( )
  if (offsetof(struct s, a) >
    offsetof(struct s, b)) die( );
  if (sizeof(struct s) != 8) die( );
}
```

These tests will cause the program to terminate if the fields of the structure are reordered, or the structure is split or augmented.

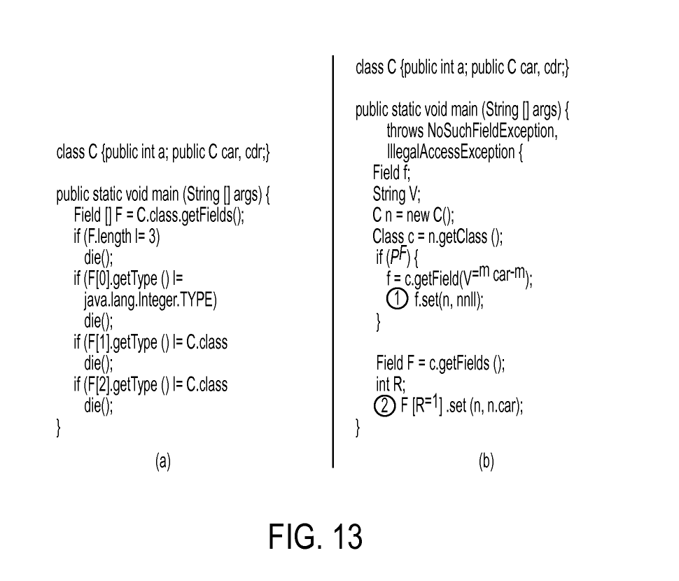

FIG. 13 (a) shows how Java's reflection package allows us to perform similar tamperproofing checks. Note that this example code is not completely general, since Java does not specify the relative order of class fields.

FIG. 13 (b) shows how we can also use opaque predicates and variables to construct code which appears to (but in fact, does not) perform “unsafe” operations on graph nodes. A de-watermarking tool will not be able to statically determine whether it is safe to apply optimising or obfuscating transformations on the code. In the example in FIG. 13 (b), V is an opaque string variable whose value is “car”, although this is difficult for a de-watermarker to work out statically. At 1 it appears as if some or all (unknown to the de-watermarker) field is being set to null, although this will never happen. The statement 2 is a redundant operation performing n.car=n.car, although (due to the opaque variable R whose value is always 1) this cannot in general be worked out statically.

For increased obscurity, the code to build the watermark should be scattered over the entire application. The only restriction is that when the end of the input sequence I=I₁ . . . Iₖ is reached, the watermark W has been constructed. This watermark in a preferred embodiment, may be composed of some or all of the components W₁, . . . Wₖ₋₁ that were constructed previously. Additionally, in a preferred embodiment, some components Wᵢ may be composed of some of all components constructed before Wᵢ.

W₀= . . . ;

if (input=I₁) W₁= . . . ;
if (input=I₂) W₂= . . . ;
if (input=Iₖ₋₁) Wₖ₋₁= . . . ;
if (input=Iₖ) Wₖ= . . . ;

In order to identify the watermark structure, the recogniser must be able to enumerate all dynamically allocated data structures. If this is not directly supported by the runtime environment (as, for example, is the case with Java), we have two choices. We can either rewrite the runtime system to give us the necessary functionality or we can provide our own memory allocator. Notice, though, that this is only necessary when we are attempting to recognise the watermark. Under normal circumstances the application can run on the standard runtime system.

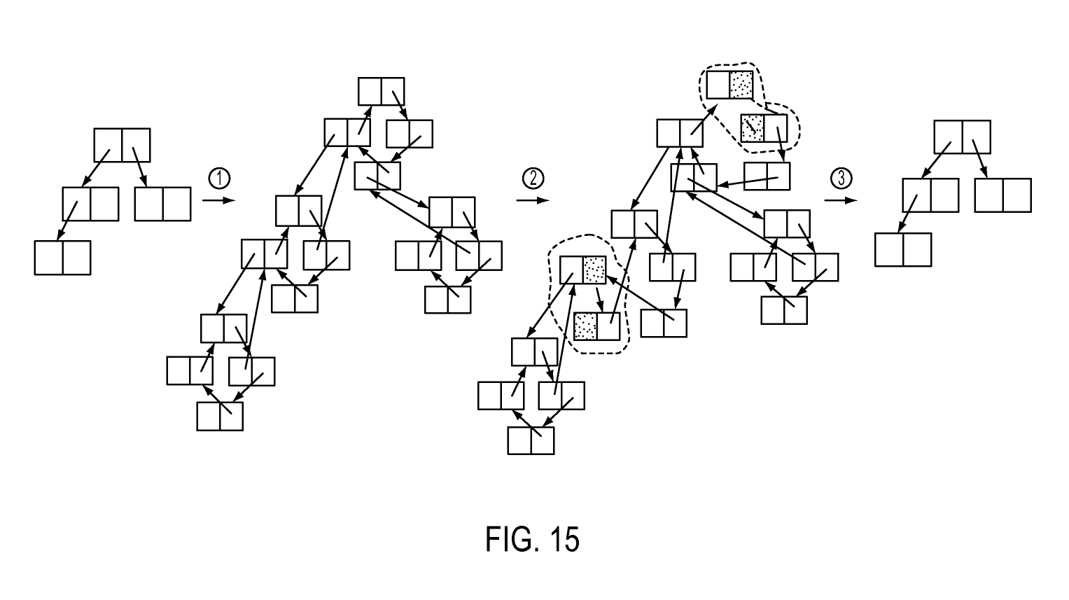

A further technique is shown in FIG. 15. Here is illustrated a technique which applies a local transformation, thereby tamperproofing the watermark against an attack by node-splitting. Each of the nodes of the original watermark graph is expanded into a 4-cycle. If an adversary splits two nodes, the underlying structure ensures that these node will fall on a cycle. At (3) the recogniser shrinks the biconnected components of the underlying graphs with the result that the graph is isomorphic to the original watermark.

It is envisaged that local transformations, other than expansion of nodes into cycles, may be employed to tamperproof the watermark against specific attacks other than node-splitting. For example, redundant edges may be introduced into the watermark in order to render the watermark tamperproof to specific attacks which involve the renaming and reordering of fields in nodes.

A number of techniques are known in the prior art for hiding copyright notices in the object code of a program. It is the inventors' belief that such methods are not resilient to attack by obfuscation—an adversary can apply a series of transformations that will hide or obscure the watermark to the extent that it can no longer be reliably retrieved.

The present invention indicates that the most reliable place to hide a watermark is within the dynamically allocated data structures of the program, as it is being executed with a particular input sequence.

A further application for the watermarking technique described above may be in “fingerprinting” software. In this case, each individual program (i.e. every distributed copy of the code) is watermarked with a different watermark. Although there is a risk of an adversary collusively attacking the watermark, the applicant believes that applying obfuscation may render it very difficult for the attacker to interpret the evidence obtained by a collusive attack.

Where in the foregoing description reference has been made to elements or integers having known equivalents, then such equivalents are included as if they were individually set forth.

Although the invention has been described by way of example and with reference to particular embodiments, it is to be understood that modifications and/or improvements may be made without departing from the scope or spirit of the invention.

1. A computer implemented method of watermarking a software object held in the memory of a watermarking computer, wherein the watermarking computer performs the following functions comprising:
(a) selecting a watermark integer by;
(b) selecting a watermark graph by the watermarking computer choosing the watermark graph corresponding to the selected watermark integer from a class of graphs having at least one property, the at least one property being an enumeration such that each member graph of the class of graphs is associated with one integer value;
(c) determining an input sequence;
(d) creating a watermark-generating program piece by the watermarking computer with generates nodes and edges of the watermark graph; and
(e) creating a watermarked software object by modifying the software object in the memory of the watermarking computer so that the watermark-generating program piece is embedded in the watermarked software object in such a way that the watermark graph generated by the watermark-generating programme piece becomes present and detectable in an execution state of the watermarked software object within a memory of an executing computer executing the watermarked software object with the input sequence, the execution state of the watermarked software object in the executing computer comprising all current values in all stacks, heaps, global variables, data registers, and program counters in the memory of the executing computer which have been modified by the executing computer while executing instructions from the watermarked software object.

2. The computer implemented method as claimed in claim 1, wherein the software object is a piece of a program.

3.-5. (canceled)

6. The computer implemented method of claim 1, wherein the enumerated graphs are distinguished by their topology and not by the use of labels on nodes or edges.

7. The computer implemented method of claim 61, wherein the watermark-generating program piece uses dynamically-allocated memory in the executing computer to store the nodes and edges of the watermark graph.

8. The computer implemented method of claim 1 further comprising the step of:
(c) building a computerized recognizer operable to examine the execution state of the watermarked software object when run with the input sequence and indicate whether the watermark is detectable in the execution state of the watermarked software object.

9. The computer implemented method of claim 8, wherein the computerized recognizer is a function adapted to identify and extract the watermark from all other dynamic structures on a heap or stack.

10. The computer implemented method of claim 8, wherein further comprising incorporating a marker that will allow the computerized recognizer to recognize the watermark.

11. The computer implemented method of claim 8, wherein the computerized recognizer is retained separately from the watermarked software object and whereby the computerized recognizer inspects the execution state of the watermarked software object.

12. The computer implemented method of claim 8, wherein the computerized recognizer is dynamically linked with the watermarked software object when it is checked for the existence of a watermark.

13. The computer implemented method of claim 1, wherein the watermarked software object is a part of an application that incorporates tamper-proofing code.

14. The computer implemented method of claim 8, wherein the computerized recognizer checks the watermark for a signature property.

15. The computer implemented method of claim 14, wherein the signature property is evaluated by testing for a specific result from a hard computational problem.

16. The computer implemented method of claim 14, the method further including the step of:
(dg) creating the watermark integer to have at least one numeric property whereby the signature property is evaluated by testing on the computerized recognizer the at least one numeric property of the watermark integer associated with the watermark graph recognised in the software object.

17. The computer implemented method of claim 16, wherein the signature property is evaluated by testing whether the watermark integer is a product of two primes.

18. The A computer implemented method of verifying the integrity or origin of a software object wherein a watermarking computer performs the following functions, including:
(a) watermarking the software object in a memory of the watermarking computer, wherein a watermark-generating program piece in the memory of the watermarking computer is embedded by the watermarking computer in the software object, in such a way that a watermark graph generated by the watermark-generating program piece becomes present and detectable in an execution state of the watermarked software object within a memory of a verifying computer executing the watermarked software object with an input sequence, the execution state of the watermarked software object in the executing computer comprising all current values in all stacks, heaps, global variables, data registers, and program counters in the memory of the executing computer which have been modified by the executing computer while executing instructions form the watermarked software object;
(b) building a computerized recognizer for use by the executing computer, wherein the computerized recognizer is adapted to extract the watermark from dynamically allocated data wherein the computerized recognizer is kept separately from the from the watermarked software object; wherein the computerized recognizer is adapted to detect the watermark by checking for a watermark integer associated with a watermark graph whose nodes and edges are identified within the execution state of the computerized recognizer.

19. The computer implemented method of claim 18, wherein the watermark integer is the product of two primes and wherein the watermark integer is the index of an embedded watermark graph in an enumeration of a class of possibly-embedded watermark graphs each having a different topology.

20. The computer implemented method of claim 18, wherein the watermark integer is derived from a combination of three or more prime numbers.

21. The computer implemented method of claim 18, wherein the watermarked software object is further adapted to be resistant to tampering, the resistance to tampering-being effected by adding tamper-proofing code.

22. The computer implemented method of claim 18, wherein the computerized recognizer checks for the effect of the said watermark graph on an execution state of the watermarked software object, thereby preserving an ability to recognize the watermark where semantics-preserving transformations have been applied to the watermarked software object.

23. (canceled)

24. A computer implemented method of watermarking software, which is a watermarking computer performing the following functions comprising:
(a) choosing a watermark from a class of graphs having a plurality of members that are stored in memory, each member of the class of graphs having at least two properties one of the properties being an association of each member graph with a distinct integer, and one of the properties being capable of being tested by integrity-testing software that examines the topology of a graph embedded in an execution state of a software object; and
(b) modifying the software stored in the memory of the watermarking computer so that the chosen watermark in the software in a manner that the watermark graph is detectable and reproducible by a computerized recognizer which examines an execution state of the watermarked software object when the watermarked software object is run on an executing computer with an input sequence determined during the watermarking process wherein the recognizer identifies nodes and edges of the watermark graph in the execution state of the executing computer.

25. The computer implemented method of claim 24, wherein the watermark is rendered tamperproof to certain transformations by subjecting the watermark graph to redundant edge insertion.

26. The computer implemented method of claim 24, wherein at least one node of the watermark graph is expanded into a cycle.

27. A computer implemented method of fingerprinting a software object, where a fingerprinting computer performs the following functions comprising:
providing a plurality of watermarked programs having a watermark graph stored in an execution state of a software object for the program by an executing computer, the execution state of the software watermarked object in the executing computer comprising all current values in all stacks, heaps, global variables, data registers, and program counters in the memory of the executing computer which have been modified by the executing computer while executing instructions from the watermarked software object as the watermarked software object is being run on the executing computer with a particular input sequence, the watermark being detectable by a computerized recognizer on the executing computer which examines the execution state of the watermarked software object as the software object is being run with a particular input sequence and identifies nodes and edges of the watermark graph within the execution state of the executing computer.

28. The computer implemented method of fingerprinting software objects as claimed in claim 27 wherein the plurality of watermarked software objects each has a number with a common prime factor.

29.-35. (canceled)

36. A computer-readable medium including a program executed on a computer for watermarking software, the program including instructions for:
(a) embedding a watermark by a watermarking computer in a static string on the watermarking computer;
(b) including in the software object a watermark-string reproduction program piece, the watermark-string reproduction program piece being executed on at least one input determined during the watermarking process that reproduces the string of step (a), and that produces at least one other string on an executing computer when code is executed with at least one other input; and
(c) using the watermarking computer to transform the watermarked software object created in step (b), using an opaque predicate to obfuscate at least one branch in a string-reproduction program piece of the watermarked software object.

37. A computer-readable medium including a program executed on a computer for watermarking software, the program including instructions for:
(a) choosing a watermark graph by a watermarking computer from a class of graphs having a plurality of members having at least one property that are stored in memory and embedding the chosen watermark graph into an execution state of a software object for the program in a memory in a manner that the watermark is detectable by a computerized recognizer which examines the execution state of an executing computer executing the program to find data elements representing nodes having one or more pointer fields representing edges, the execution state of the watermarked software object in the executing computer comprising all current values in all stacks, heaps, global variables, data registers, and program counters in the memory of the executing computer which have been modified by the executing computer while executing instructions from the watermarked software object as the watermarked software object is being run on the computer with a particular input sequence;
(b) providing the computerized recognizer on the computer-readable medium; and
(c) providing an integrity tester on the computer-readable medium which tests for the satisfaction of the at least one property in a possibly-modified version of the watermarked software object.

38. A computer capable of verifying at least one of the integrity and origin of a software object, the computer comprising:
an input sequence;
a watermark graph for watermarking the software object, wherein nodes and edges of the watermark graph are created in a dynamic data structure in the memory of the computer when the watermarked software object is being run with the input sequence,
a computerized recognizer, wherein the computerized recognizer is adapted to extract the data structure for the watermark from other dynamically allocated data wherein the computerized recognizer is kept separately from the watermarked software object, wherein the computerized recognizer is adapted to check for a number associated with the watermark.

39. A watermarking computer for watermarking software comprising:
(a) a memory for storing data representing a string that has a watermark embedded in it;
(b) a memory for storing a program piece;
(c) a watermarking program piece constructed to accept at least one input determined during a watermarking process such that the watermarking program piece will produce a watermark string which is detectable in the execution state of an executing computer by a computerized recognizer on the executing computer, and such that the watermarking program piece will produce at least one other string in the execution state of the executing computer when executed with at least one other input; and
(d) obfuscating code constructed to obfuscate the watermarking program piece stored on the watermarking computer using at least one opaque predicate, and introduce the obfuscated watermarked program piece into the software.

40. A computer comprising:
(a) a watermarked software object obtained by choosing a watermark graph from a class of graphs having a plurality of members having at least one property, and embedding the chosen watermark graph into an execution state of a software object for the program in a memory of the computer when executing the program in a manner that the watermark is detectable by a computerized recognizer in the computer, the execution state of the watermarked software object in the executing computer comprising all current values in all stacks, heaps, global variables, data registers, and program counters in the memory of the executing computer which have been modified by the executing computer which executing instructions from the watermarked software object as the watermarked software object is being run on the computer with a particular input sequence;
(b) a computerized recognizer capable of recognizing the embedded watermark graph by examining the execution state of the watermarked software object when it is being executed on the computer;
(c) an integrity tester which tests for the satisfaction of the at least one property in a possibly-modified version of the watermarked software object.

41. The computer implemented method of claim 1, wherein the watermark is detectable in any portion of the dynamic data state of the software object.

42. The computer implemented method of claim 1, wherein the software object is an executable media object.

43. The computer implemented method of claim 1, further comprising creating a watermark-generating program piece with the property that no visual or audible change is apparent to the user of the watermarked software object when the watermark becomes detectable in the execution state of the watermarked software object on the executing computer.

44. The computer implemented method of claim 8, further comprising building the computerized recognizer concurrently with the watermark and input sequence.

45. The computer implemented method of claim 16, wherein the enumerated graphs are distinguished by their topology and not by the use of labels on nodes or edges.

46. The computer implemented method of claim 18, further comprising building the computerized recognizer concurrently with the watermark and input sequence.

47. The computer implemented method of claim 27, further comprising creating a watermark-generating program piece with the property that no visual or audible change is apparent to the user of the watermarked software object when the watermark becomes detectable in the execution state of the watermarked software object on the executing computer.

48. A computer implemented method of watermarking a software object, wherein a watermarking computer performs the following functions comprising:
a) determining at least one input sequence;
b) determining at least one property of an execution trace comprising one or more of:
i) the sequence of addresses from which executed instructions are fetched from the memory of the executing computer executing the software object on the input sequence;
ii) the sequence of instructions in the software object that are executed by the executing computer executing the watermarked software object on the input sequence.
c) making multiple measurements of the at least one execution-trace property for the watermarked software object by measuring the at least one execution-trace property of the software object when it is executed with the at least one input sequence on at least one executing computer;
d) creating a watermark signature property for the software object by computing the likely range of measured values for the at least one execution-trace property when the software object is executed with the at least one input sequence on a typical executing computer.

49. A computer implemented method for watermarking a software object, wherein a watermarking computer performs the following functions comprising:
a) selecting a watermark
b) embedding the watermark in a string;
c) determining an input sequence;
d) creating a watermarked software object by modifying the software object so that the watermark becomes present and detectable in an execution state of the software object within a memory of an executing computer executing the watermarked software object with the input sequence, the execution state of the watermarked software object in the executing computer comprising all current values in all stacks, heaps, global variables, data registers, and program counters in the memory of the executing computer which have been modified by the executing computer while executing instructions from the watermarked software object with the input sequence, such that some values in said execution state correspond to characters in said watermark string;
e) modifying the software object so that the watermark will not become present or detectable in an execution state of the watermarked software object whenever the watermarked software object is run with an input different to the input sequence; and
f) further modifying the software object by introducing at least one opaque predicate to obfuscate at least one of the branches in said software object, so that the target of said branch cannot be computed by a static analysis of said software object, thereby producing a watermarked software object whose watermark string is opaque to static analysis.

50. A method as claimed in claim 1 further comprising associating each edge of the watermark graph with a pointer field in the execution state of the software object.

51. A method as claimed in claim 18 further comprising associating each edge of the watermark graph with a pointer field in the execution state of the software object.
